(19) United States
(12) Patent Application Publication
(10) Pub. No.: US 2026/0322581 A1
(43) Pub. Date: Oct. 15, 2026

(54) SIGNAL TRANSMISSION METHOD, TRANSMISSION DEVICE AND SYSTEM UTILIZING THE SAME

(71) Applicant: Joulwatt Technology Co., Ltd., Hangzhou (CN)

(72) Inventors: Yang CHENG, Hangzhou (CN); Pitleong WONG, Hangzhou (CN); Haitao WEN, Hangzhou (CN)

(21) Appl. No.: 19/647,614

(22) Filed: Apr. 14, 2026

(30) Foreign Application Priority Data
Apr. 15, 2025 (CN) 202510475420.3

(51) Int. Cl. H04L 7/00; G06F 13/42

(52) U.S. Cl. CPC H04L 7/0091; G06F 13/4291; H04L 7/0079

(57) ABSTRACT

Disclosed is a signal transmission method, a transmission device, and a system. A master device and at least one slave device, which is pre-configured with a sequence for instruction execution, are connected through a single bus. After the master device sends the instruction set through the single bus, the at least one slave device sequentially acquires its corresponding instruction from the instruction set according to the sequence of the instruction set and executes corresponding operation. The instruction set has one or more special instruction signals, each having a characteristic different from that of a normal instruction signal and serving as a basis for determining a sequence of the at least one slave device. Thus, rapid instruction transmission can be achieved through the single bus. Within one cyclic period, each slave device can obtain its accurate position in the sequence of the instruction set, with high robustness.

### CROSS-REFERENCE TO RELATED APPLICATIONS

The present application claims priority to Chinese Patent Application No. 202510475420.3, filed on Apr. 15, 2025, entitled "SIGNAL TRANSMISSION METHOD, TRANSMISSION DEVICE AND System UTILIZING THE SAME", the entire content of which is incorporated herein by reference, including the full text of the specification, claims, drawings, and abstract.

### TECHNICAL FIELD

The present invention relates to a field of power electronics technology, and more particularly, to a signal transmission method, a transmission device, and a system utilizing the same.

### BACKGROUND

When multiple devices such as multiple circuits, multiple chips, or multiple modules work together in coordination, signal transmission among the multiple devices is required to achieve information interaction. Signal transmission needs to respond quickly. Existing solutions include I2C and SPI communication transmission methods. These transmission methods often require the master device to transmit information through packet-based transmission, and the slave device needs to identify addresses and perform packet parsing before executing instructions, thereby incurring a significant delay. Moreover, these communications often require two buses (i.e., a clock line and a data line) to complete signal transmission, which is often unsuitable in scenarios requiring rapid execution of instructions.

### SUMMARY OF THE DISCLOSURE

In view of this, an object of the present invention is to provide a signal transmission method, a transmission device, and a system utilizing the same, to solve a technical problem of large signal transmission delay and excessive transmission lines existing in the prior art.

According to a first aspect of the present application, a signal transmission method is provided for performing signal transmission among a plurality of devices, wherein the plurality of devices comprise a master device and at least one slave device connected through a single bus. The method comprises: sending, by the master device, a preset instruction set through the single bus; and pre-configuring the at least one slave device with a sequence for instruction execution, such that after the master device sends the instruction set, each of the at least one slave device sequentially acquires its corresponding instruction from the instruction set according to a sequence of the instruction set and executes corresponding operation according to its corresponding instruction. The instruction set is provided with one or more special instruction signals, each of which has a characteristic different from that of a normal instruction signal and serves as a basis for determining a sequence of the at least one slave device.

Optionally, when the instruction set is provided with one special instruction signal, the special instruction signal serves as an operating instruction signal for the master device, and the normal instruction signal serves as an operating instruction signal for the at least one slave device; or alternatively, the special instruction signal serves as an operating instruction signal for one of the at least one slave device, and the normal instruction signal serves as an operating instruction signal for the master device and other of the at least one slave device (if any).

Optionally, when the instruction set is provided with two special instruction signals, a first special instruction signal serves as an operating instruction signal for the master device, a second special instruction signal serves as an operating instruction signal for a certain one of the at least one slave device, and the normal instruction signal serves as an operating instruction signal for other one of the at least one slave device (if any).

Optionally, within one cyclic period of the instruction set, the at least one slave device sequentially completes acquisition and/or calibration of its own instruction signal.

Optionally, the instruction set comprises a plurality of clock signals, and the corresponding operation executed by each of the at least one slave device comprises performing working operation according to the plurality of clock signals.

Optionally, the characteristic for distinguishing the special instruction signal from the normal instruction signal is configured as: the special instruction signal has a voltage level threshold higher or lower than that of the normal instruction signal.

Optionally, the characteristic for distinguishing the special instruction signal from the normal instruction signal is configured as: the special instruction signal has a pulse width greater than or less than that of the normal instruction signal, or the special instruction signal has more or fewer pulses than the normal instruction signal.

Optionally, the method further comprises determining a sequence of the master device and the at least one slave device by setting different parameters, which comprise resistance values, voltage values, or capacitance values.

According to a second aspect of the present application, a signal transmission device is provided for signal transmission among a plurality of devices. The plurality of devices comprises a master device and at least one slave device connected through a single bus. The master device comprises a signal generation circuit for generating an instruction set, which is sent through the single bus. Each of the at least one slave device comprises a signal recognition circuit, and the at least one slave device is pre-configured with a sequence for instruction execution. The signal recognition circuit sequentially acquires its corresponding instruction from the instruction set according to a sequence of the instruction set and executes corresponding operation according to its corresponding instruction. The instruction set is provided with one or more special instruction signals, each of which has a characteristic different from that of a normal instruction signal and serves as a basis for determining a sequence of the at least one slave device.

Optionally, within one cyclic period of the instruction set, the at least one slave device sequentially completes acquisition and/or calibration of its own instruction signal.

Optionally, the master device and the at least one slave device each receive different external parameter signals that serve as positioning signals for the master device and the at least one slave device, wherein the parameter signals comprise resistance values, voltage values, or capacitance values.

Optionally, the external parameter signals received by the at least one slave device are set to be different, and the at least one slave device each determines its ordinal position according to an external frequency signal received thereby, so as to obtain its corresponding instruction according to the ordinal position.

Optionally, the signal recognition circuit comprises a signal comparison circuit and a signal extraction circuit. The signal comparison circuit is configured to compare a magnitude of a corresponding signal of the instruction set with a preset standard value to determine a position of the special instruction signal. The signal extraction circuit, connected to an output terminal of the signal comparison circuit, is configured to extract an operating instruction signal for a current stage according to an address signal of that slave device itself after receiving a position signal of the special instruction signal.

According to a third aspect of the present application, a system is provided comprising the signal transmission device according to any embodiment of the second aspect. The master device and the at least one slave device are used to supply power to a load, and the system is configured to select at least one device from the master device and the at least one slave device to supply power to the load according to a power requirement of the load.

Optionally, the master device comprises a master control and driving circuit and a master power stage circuit. The signal generation circuit is configured to generate an instruction set comprising a master clock signal and at least one slave clock signal. The master clock signal is transmitted to the master control and driving circuit, which is configured to control the master power stage circuit to perform power conversion according to the master clock signal.

Optionally, each of the at least one slave device comprises a slave control and driving circuit and a slave power stage circuit. The signal recognition circuit is configured to receive the instruction set to recognize the special instruction signal, and extract its own slave clock signal to transmit to the slave control and driving circuit, which is configured to control the slave power stage circuit to perform power conversion according to the slave clock signal.

Optionally, the master device and the at least one slave device operate in phase interleaving according to the master clock signal and the at least one slave clock signal.

Optionally, the master device is configured to receive a feedback signal representing load power, and generate a digital signal according to the feedback signal. Each of the at least one slave device is configured to receive the digital signal and determine whether to enable operation accordingly.

By adopting the signal transmission method, the transmission device, and the system utilizing the same according to the embodiments of the present invention, the master device and the at least one slave device are connected through a single bus, the master device transmits a preset instruction set through the single bus, the at least one slave device is pre-configured with a sequence for instruction execution, and after the master device transmits the instruction set, the at least one slave device sequentially obtains its corresponding instruction according to the sequence of the instruction set and executes corresponding operation, wherein the instruction set is provided with one or more special instruction signals, each of which has a characteristic different from that of a normal instruction signal and serves as a basis for determining a sequence of the at least one slave device. Through the technical solution according to the embodiments of the present application, on one hand, fast transmission of instructions can be realized through the single bus, and on the other hand, by setting one or more special instruction signals, each slave device can check its instruction position in the instruction set within one cyclic period to obtain an accurate instruction signal, resulting in high robustness.

### BRIEF DESCRIPTION OF THE DRAWINGS

FIG. 1 is a circuit block schematic diagram of a signal transmission device according to an embodiment of the present disclosure;

FIG. 2 is a circuit block schematic diagram of a master device according to an embodiment of the present disclosure;

FIG. 3 is a circuit block schematic diagram of a slave device according to an embodiment of the present disclosure;

FIG. 4 is a schematic diagram showing different characteristics of a special instruction signal according to an embodiment of the present disclosure;

FIG. 5 shows an implementation of a signal recognition circuit of the slave device as shown in FIG. 3;

FIG. 6 is a circuit block schematic diagram of a system according to an embodiment of the present disclosure;

FIG. 7 is a flowchart of a signal transmission method according to an embodiment of the present disclosure.

### DETAILED DESCRIPTION

Preferred embodiments of the present invention will be described in detail below with reference to the accompanying drawings, but the present invention is not limited to these embodiments. The present invention covers any alternatives, modifications, equivalent methods, and schemes made within the spirit and scope of the present invention.

In order to enable the public to have a thorough understanding of the present invention, specific details are described in detail in the following preferred embodiments of the present invention, while those skilled in the art can fully understand the present invention without the description of these details.

The present invention is described more specifically by way of example with reference to the drawings in the following paragraphs. It should be noted that the drawings are all in a relatively simplified form and use non-accurate proportions, only for the purpose of facilitating and clearly assisting in illustrating the embodiments of the present invention.

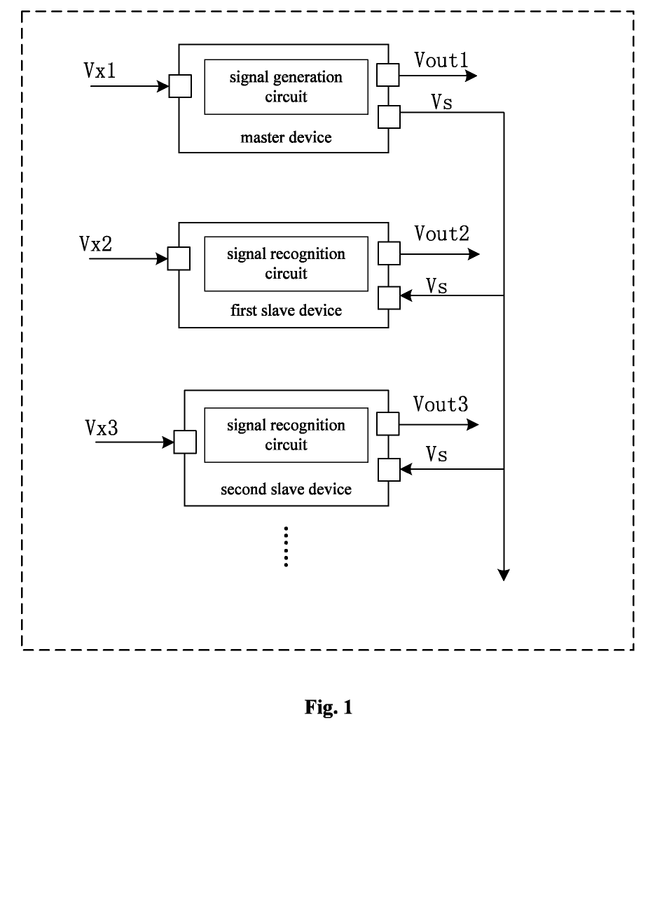

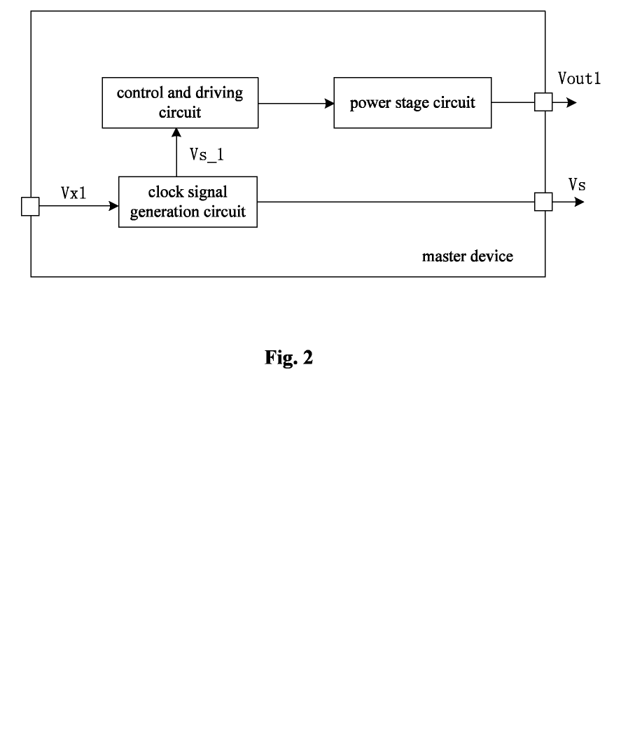

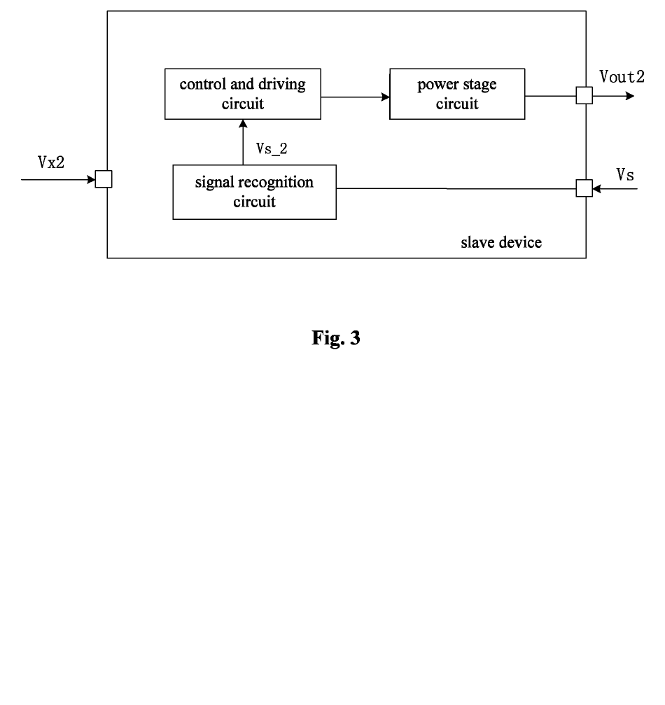

FIG. 1 is a circuit block schematic diagram of a signal transmission device according to an embodiment of the present disclosure, and FIGS. 2 and 3 are circuit block schematic diagrams of a master device and a slave device according to an embodiment of the present disclosure. As shown in FIG. 2, the signal transmission device of the present application is used for signal transmission among a plurality of devices, the plurality of devices includes a master device and at least one slave device, wherein the master device and the at least one slave device are connected through a single bus. In this embodiment, two slave devices are taken as an example, and a device in the embodiment may be an apparatus, a module, a chip, a circuit, or the like. The single bus may be a clock bus or other single bus which is suitable. The master device comprises a signal generation circuit, which may be a clock signal generation circuit or other communication signal generation circuit for generating an instruction set, herein the instruction set is denoted as Vs. The instruction set is transmitted through the single bus, and in this embodiment, the instruction set including clock signals is taken as an example. Each slave device includes a signal recognition circuit, and the at least one slave device is pre-configured with a sequence for instruction execution. According to the sequence of the instruction set, the signal recognition circuit of the at least one slave device sequentially obtains its corresponding instruction and executes corresponding operation according to its corresponding instruction. Wherein, the instruction set is provided with one or more special instruction signals, each of which has a characteristic different from that of a normal instruction signal and serves as a basis for determining the sequence of the at least one slave device. Here, the sequence for instruction execution which is pre-configured to the at least one slave device can be set as follows: the master device and the at least one slave device all receive different external parameter signals, which serve as address signals, i.e., positioning signals for the master device and the at least one slave device, the external parameter signals are, for example, resistance values, voltage values, or capacitance values. Preferably, the external parameter signals received by the at least one slave device are set to be different, and each slave device is configured to determine its address information, i.e., position order, according to the external parameter signal received thereby, so as to obtain its corresponding instruction according to the address order. For example, in FIG. 2, Vx1 is a first voltage value, and Vx2 and Vx3 are second and third voltage values. The voltage values are set differently, thus when a device receives a corresponding voltage value, it can be determined whether that device is configured to serve as the master device or one slave device at a corresponding position in the sequence of the at least one slave device.

For example, within one cyclic period of the instruction set, each slave device sequentially completes acquisition and/or calibration of its respective instruction signal. Here, a cyclic period of the instruction set is defined as an interval from the start of a certain instruction signal to the start of the next occurrence of that instruction signal. Each slave device can use a special instruction signal as a basis for position determination. For example, when the special instruction signal is an operating instruction for the first slave device, a signal subsequent to the special instruction signal serves as the operating instruction signal for the second slave device, thereby enabling each slave device to obtain its corresponding operating instruction signal. Secondly, when an error occurs in the instruction signal, the corresponding slave device can re-acquire its correct operating instruction signal in the next cyclic period according to the position of the special instruction signal, thereby calibrating its own instruction signal.

In some embodiments, when the instruction set is provided with one special instruction signal, the special instruction signal serves as the operating instruction signal for the master device, and the normal instruction signal(s) serves as the operating instruction signal(s) for the slave device(s); or, the special instruction signal serves as the operating instruction signal for one of the at least one slave device, and the normal instruction signal(s) serves as the operating instruction signal(s) for the master device and other of the at least one slave device (if any). When the instruction set is provided with a plurality of special instruction signals, a first special instruction signal serves as the operating instruction signal for the master device, a second special instruction signal serves as the operating instruction signal for a certain one of the at least one slave device, and the normal instruction signal(s) serves as the operating instruction signal(s) for other of the at least one slave device (if any). That is, the special instruction signal can serve as the operating instruction signal for either the master device or one slave device. As long as the device corresponding to the special instruction signal is positioned in advance, it can serve as a position calibration reference.

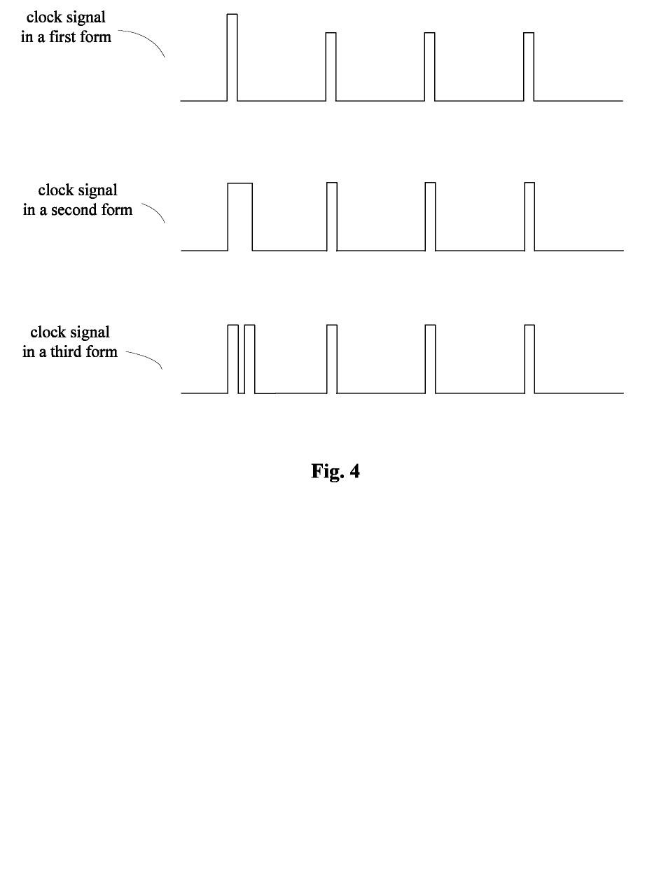

Referring to the waveform diagram as shown in FIG. 4, in a first example, a characteristic for distinguishing the special instruction signal from the normal instruction signal is configured as: the special instruction signal has a voltage level threshold higher than or lower than that of the normal instruction signal. In another example, a characteristic for distinguishing the special instruction signal from the normal instruction signal is configured as: the special instruction signal has a pulse width greater than or less than that of the normal instruction signal, or the special instruction signal has more or fewer pulses than the normal instruction signal. Based on the characteristic of the special instruction signal, the operating cycle and the operating state can be well determined in every cyclic period. Those skilled in the art can appreciate that the special instruction signal may be presented in other forms, and the present application imposes no limitation on the specific form thereof.

With continued reference to FIGS. 2, 3, and 4, the master device in this embodiment comprises a master control and driving circuit and a master power stage circuit. The signal generation circuit generates the instruction set including a master clock signal and at least one slave clock signal (e.g., a plurality of slave clock signals), and the signal generation circuit transmits the master clock signal Vs_1 to the master control and driving circuit. The master control and driving circuit controls the master power stage circuit to perform power conversion according to the master clock signal. Each of the plurality of slave devices comprises a slave control and driving circuit and a slave power stage circuit. The signal recognition circuit receives the instruction set to obtain a clock signal for that slave device, such as Vs_n, and transmits the extracted clock signal Vs_n to the slave control and driving circuit. The slave control and driving circuit controls the slave power stage circuit to perform power conversion according to the corresponding slave clock signal. In this example, according to the master clock signal and the plurality of slave clock signals, the master device and the plurality of slave devices operate in phase interleaving, whereby the output power and output ripple of the system can be well controlled. On one hand, operating devices can be configured according to the power requirement of the load, and on the other hand, interleaved operating configuration can reduce the output ripple. It should be noted that the master device may further include other signals, such as a clock recognition signal, and each slave device may further include other signals, such as a local clock generation signal, which are not shown herein. In the master device and the slave devices, the control and driving circuits and power stage circuits may have existing circuit structures.

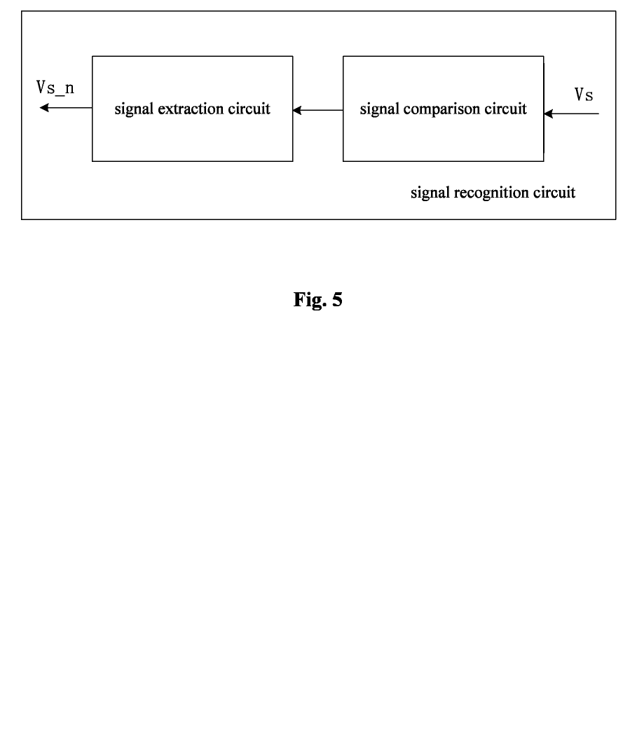

Referring to FIG. 5, which shows an implementation of the signal recognition circuit, the signal recognition circuit comprises a signal comparison circuit and a signal extraction circuit. The signal comparison circuit compares a signal of the instruction set with a preset standard value to determine a position of the special instruction signal. The signal extraction circuit is connected to an output terminal of the signal comparison circuit. When receiving a position signal of the special instruction signal, the signal extraction circuit extracts the operating instruction signal for a current stage according to an address signal of the current device. The signal comparison circuit may be implemented by a comparator, and the signal extraction circuit may be implemented by a counter. For example, the special instruction signal may serve as a reset signal for the counter, allowing the counter to well extract the instruction signal for the current device.

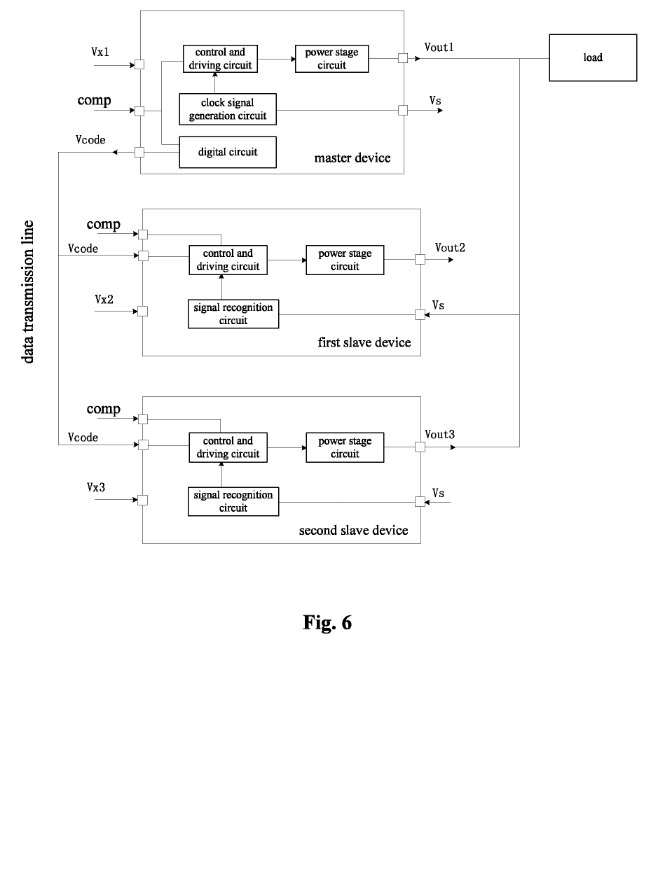

Referring to FIG. 6, an embodiment of the present application provides a system including the above-mentioned signal transmission device, wherein the master device and the slave device are used to supply power to a load, and the system is configured to select at least one of the master device and the plurality of slave devices to supply power to the load according to a power requirement of the load. The system in this embodiment may be a power supply system or other power consumption system. As shown in FIG. 6, the output voltage of the master device is Vout1, the output voltage of the first slave device is Vout2, and the output voltage of the second slave device is Vout3. According to the power magnitude of the load, an optimal combination can be selected from the master device and the plurality of slave devices to meet the power supply requirement to the load.

Preferably, in the present application, the signal generation circuit, the control and driving circuit, and the power stage circuit of the master device may be integrated in one chip, or the signal generation circuit may be in one chip while the control and driving circuit and the power stage circuit may be integrated in another chip. However, the present invention imposes no limitation thereon.

The system according to the present application can meet load requirements within different ranges through the combined utilization of the master device and the slave device(s). In one example, the master device receives a feedback signal comp representing load power, and generates a digital signal Vcode (generated by a digital circuit) according to the feedback signal, the digital signal Vcode is transmitted to each slave device through a data transmission line, and each slave device receives the digital signal and determines whether to enable operation accordingly. For example, when the digital signal of the master device indicates that the first slave device needs to operate while the second slave device does not need to operate, the first slave device starts to operate and the second slave device is disabled; at this time, by supplying power to the load together by the master device and the first slave device, a desired output power can be provided. Through the above manner, an optimal combination can be selected from the master device and the slave device(s); here, the master device and the slave device(s) each receive the feedback signal comp, and when a device among them needs to operate, its control and driving circuit performs feedback control according to the received feedback signal comp, so that the power stage circuit can operate normally and output an appropriate power magnitude. In another example, the master device and the slave device(s) each receive the feedback signal comp representing load power, and whether to enable operation of a device among them can be determined according to the feedback signal, that is, the master device does not generate the digital signal, and each slave device itself determines whether to start operating according to the feedback signal comp.

According to the above transmission method and device, the master device and the at least one slave device are connected through a single bus, the master device sends a preset instruction set through the single bus, the at least one slave device is pre-configured with the sequence for instruction execution, and after the master device sends the instruction set, the at least one slave device sequentially obtains its corresponding instruction according to the sequence of the instruction set and executes the corresponding operation, wherein the instruction set is provided with one or more special instruction signals, each of which has a characteristic different from that of the normal instruction signal(s) and serves as a basis for sequence determination of the at least one slave device. Through the technical solutions according to the embodiments of the present application, on one hand, rapid transmission of instructions can be achieved through the single bus, and on the other hand, by using the special instruction signal(s), each slave device can check its instruction position in the instruction set within one cyclic period to obtain an accurate instruction signal, with high robustness. The signal transmission scheme according to embodiments of the present application is simple and easy to implement, and thus can be used for signal transmission in different devices, and is of low cost and high efficiency.

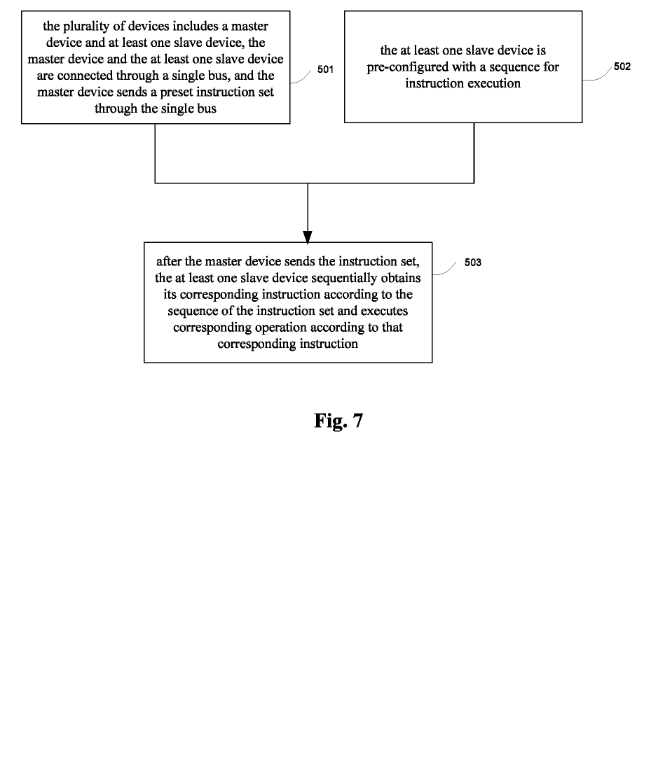

Referring to FIG. 7, which is a flowchart of a signal transmission method, including steps 501, 502 and 503, according to an embodiment of the present invention. First, positions of the master device and each slave device can be determined through address parameters, the at least one slave device is pre-configured with a sequence for instruction execution (see step 502), the master device and the at least one slave device are connected through a single bus, and the master device sends a preset instruction set through the single bus (see step 501); then, after the master device sends the instruction set, the at least one slave device sequentially obtains its corresponding instruction according to the sequence of the instruction set and executes corresponding operation according to that corresponding instruction (see step 503); wherein the instruction set is provided with one or more special instruction signals, each of which has a characteristic different from that of a normal instruction signal and serves as a basis for determining a sequence of the at least one slave device.

It should be noted that the specific embodiments and corresponding illustrations provided are merely one way of describing the embodiments of the present invention, and are not intended to limit the specific structure of the embodiments. Without departing from the principle and essence of the present invention, various changes or modifications may be made to these embodiments, all of which fall within the protection scope of the present invention.

Although described separately above, the embodiments may be interchanged and combined with respect to common technical features, as would be apparent to those of ordinary skill in the art; content not explicitly described in one embodiment may be referenced from another embodiment.

The above-described embodiments are not intended to limit the scope of protection of the technical solution. Any modifications, equivalents, and improvements falling within the spirit and principle of the above embodiments fall within the scope of protection of the technical solution.

What is claimed is:

1. A signal transmission method for performing signal transmission among a plurality of devices, wherein the plurality of devices comprise a master device and at least one slave device, the master device and the at least one slave device are connected through a single bus, and the signal transmission method comprises:
sending, by the master device, a preset instruction set through the single bus;
pre-configuring the at least one slave device with a sequence for instruction execution, and after the master device sends the instruction set, each of the at least one slave device sequentially acquiring its corresponding instruction from the instruction set according to a sequence of the instruction set and executing corresponding operation according to its corresponding instruction;
wherein the instruction set is provided with one or more special instruction signals, each of which has a characteristic different from that of a normal instruction signal and serves as a basis for determining a sequence of the at least one slave device.

2. The signal transmission method according to claim 1, wherein when the instruction set is provided with one special instruction signal, the special instruction signal serves as an operating instruction signal for the master device, and the normal instruction signal serves as an operating instruction signal for the at least one slave device; or the special instruction signal serves as an operating instruction signal for one of the at least one slave device, and the normal instruction signal serves as an operating instruction signal for the master device and other of the at least one slave device.

3. The signal transmission method according to claim 1, wherein when the instruction set is provided with two special instruction signals, a first special instruction signal serves as an operating instruction signal for the master device,
a second special instruction signal serves as an operating instruction signal for a certain one of the at least one slave device, and the normal instruction signal serves as an operating instruction signal for other of the at least one slave device.

4. The signal transmission method according to claim 1, wherein within one cyclic period of the instruction set, the at least one slave device sequentially completes acquisition and/or calibration of its own instruction signal.

5. The signal transmission method according to claim 1, wherein the instruction set comprises a plurality of clock signals, and the corresponding operation executed by each of the at least one slave device comprises performing working operation according to the plurality of clock signals.

6. The signal transmission method according to claim 1, wherein the characteristic for distinguishing the special instruction signal from the normal instruction signal is configured as: the special instruction signal has a voltage level threshold higher or lower than that of the normal instruction signal.

7. The signal transmission method according to claim 1, wherein the characteristic for distinguishing the special instruction signal from the normal instruction signal is configured as: the special instruction signal has a pulse width greater than or less than that of the normal instruction signal, or the special instruction signal has more or fewer pulses than the normal instruction signal.

8. The signal transmission method according to claim 1, comprising:
determining a sequence of the master device and the at least one slave device by setting different parameters, which comprise resistance values, voltage values, or capacitance values.

9. A signal transmission device for signal transmission among a plurality of devices, wherein,
the plurality of devices comprises a master device and at least one slave device, the master device and the at least one slave device are connected through a single bus,
the master device comprises a signal generation circuit for generating an instruction set, which is sent through the single bus;
each of the at least one slave device comprises a signal recognition circuit, and the at least one slave device is pre-configured with a sequence for instruction execution, the signal recognition circuit sequentially acquires its corresponding instruction from the instruction set according to a sequence of the instruction set and executes corresponding operation according to its corresponding instruction;
wherein the instruction set is provided with one or more special instruction signals, each of which has a characteristic different from that of a normal instruction signal and serves as a basis for determining a sequence of the at least one slave device.

10. The signal transmission device according to claim 9, wherein within one cyclic period of the instruction set, the at least one slave device sequentially completes acquisition and/or calibration of its own instruction signal.

11. The signal transmission device according to claim 9, wherein the master device and the at least one slave device each receive different external parameter signals that serve as positioning signals for the master device and the at least one slave device, wherein the parameter signals comprise resistance values, voltage values, or capacitance values.

12. The signal transmission device according to claim 11, wherein the external parameter signals received by the at least one slave device are set to be different, and the at least one slave device each determines its ordinal position according to an external frequency signal received thereby, so as to obtain its corresponding instruction according to the ordinal position.

13. The signal transmission device according to claim 11, wherein the signal recognition circuit comprises a signal comparison circuit and a signal extraction circuit,
the signal comparison circuit is configured to compare a magnitude of a corresponding signal of the instruction set with a preset standard value to determine a position of the special instruction signal,
and the signal extraction circuit, connected to an output terminal of the signal comparison circuit, is configured to extract an operating instruction signal for a current stage according to an address signal of that slave device itself after receiving a position signal of the special instruction signal.

14. The signal transmission device according to claim 9, wherein the characteristic for distinguishing the special instruction signal from the normal instruction signal is configured as: the special instruction signal has a voltage level threshold higher or lower than that of the normal instruction signal.

15. The signal transmission device according to claim 9, wherein the characteristic for distinguishing the special instruction signal from the normal instruction signal is configured as: the special instruction signal has a pulse width greater than or less than that of the normal instruction signal, or the special instruction signal has more or fewer pulses than the normal instruction signal.

16. A system comprising the signal transmission device according to claim 9, wherein the master device and the at least one slave device are used to supply power to a load,
and the system is configured to select at least one device from the master device and the at least one slave device to supply power to the load according to a power requirement of the load.

17. The system according to claim 16, wherein the master device comprises a master control and driving circuit and a master power stage circuit,
the signal generation circuit is configured to generate the instruction set comprising a master clock signal and at least one slave clock signal, the master clock signal is transmitted to the master control and driving circuit, which is configured to control the master power stage circuit to perform power conversion according to the master clock signal.

18. The system according to claim 17, wherein each of the at least one slave device comprises a slave control and driving circuit and a slave power stage circuit,
the signal recognition circuit is configured to receive the instruction set to recognize the special instruction signal, and extract its own slave clock signal to transmit to the slave control and driving circuit, which is configured to control the slave power stage circuit to perform power conversion according to that slave clock signal.

19. The system according to claim 17, wherein the master device and the at least one slave device operate in phase interleaving according to the master clock signal and the at least one slave clock signal.

20. The system according to claim 16, wherein the master device is configured to receive a feedback signal representing load power,
and generate a digital signal according to the feedback signal, each of the at least one slave device is configured to receive the digital signal and determine whether to enable operation accordingly.
